(19) United States
(12) Patent Application Publication
(10) Pub. No.: US 2009/0193265 A1
(43) Pub. Date: Jul. 30, 2009

(54) FAST DATABASE INTEGRITY PROTECTION APPARATUS AND METHOD

(75) Inventors: Stefan Andersson, Klagerup (SE); Marcus Liwell, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/025,885

(22) Filed: Feb. 5, 2008

Related U.S. Application Data
(60) Provisional application No. 61/023,537, filed on Jan. 25, 2008.

(51) Int. Cl. H04L 9/06; G06F 17/30

(52) U.S. Cl. 713/189; 707/201; 707/E17.005

(57) ABSTRACT

An apparatus and method of protecting the integrity of a database is provided. Protection of the database is implemented by randomly selecting part of the database that is to be authenticated, the part of the database being less than the entire database to be authenticated. Then, only the selected part of the database is processed through a security function to generate a representation of authentication of the database for comparison with another representation of authentication of the database. Based on a comparison of the representation of authentication and the another representation of authentication, it is determined if integrity of the database has been maintained.

### RELATED APPLICATION DATA

This application claims priority of U.S. Provisional Application No. 61/023,537 filed on Jan. 25, 2008, which is incorporated herein by reference in its entirety.

### TECHNICAL FIELD OF THE INVENTION

The present invention relates generally to database protection and, more particularly, to an apparatus and method for providing fast integrity protection of a database accessible by an electronic device, for example a portable electronic device, such as a mobile phone, or other device.

### DESCRIPTION OF THE RELATED ART

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

Certain features implemented on electronic devices may employ the use of one or more databases or the like. Such databases can store information used by software applications that reside on the electronic device or applications that are external to the electronic device. The information can include, for example, contacts (e.g., names and corresponding phone numbers, email addresses, etc. accessed by a contact manager), URLs (e.g., favorite web pages accessed by a web browser), file locations (e.g., locations of pictures, movies, music, etc. accessed by a content manager), etc. Additionally, the one or more databases, for example, may be stored in non-volatile memory of the electronic device (e.g., internal non-volatile memory) or in memory of a removable non-volatile memory card or the like.

In certain situations it is desirable to protect the integrity of a database, e.g., to prevent an attack on the database and/or to determine whether or not there was such an attack or some event that has compromised the integrity of the database. This is particularly true when the data stored in the database relates to monetary data, licensing data, or any other data that should not be altered in an unauthorized manner. One approach that can be implemented to secure the database is known as replay protection. Replay protection refers to a protection scheme that prevents old valid data records from being reintroduced in the database. Such records could contain, for example, transaction counters that may be a target for an attack on the database. Replay protection may be employed to protect unauthorized access to sensitive data (such as transaction counters) stored in the database (e.g., to prevent unauthorized modification of data corresponding to prepaid tokens or data corresponding to licensed media content).

For example, a user may purchase a license to view a movie on the electronic device, wherein the license grants the user a predetermined time period in which he may watch the movie (e.g., 1 week). This time period, along with data identifying the corresponding media content (e.g., a file name), can be stored in the database. As a user requests playback of the media content, the electronic device can retrieve from the database the time period corresponding to the media content, and compare that time period to the current date. If the current date falls within the authorized time period as specified in the database, then the electronic device will render the media content. However, if the current date falls outside the authorized time period, then the electronic device will not render the media content.

Another example applies to prepaid tokens for various goods or services. This can include prepaid tokens for electronically paying for goods and services (e.g., electronically buying music, paying for public transportation, access to certain toll roads, etc.). If a user wishes to pay for a particular good or service, a token value stored in the database of the electronic device may be automatically debited from the user's database and credited to the seller. As is evident, it is desirable to prevent unauthorized modification of the time period, token value, etc. stored in the database.

A prior method of protecting database integrity required providing the entire database with integrity protection. Such prior device and method included providing the entire database to a message authentication code device that would prepare, e.g., to compute or otherwise to form, a database authentication message code, e.g., a checksum value (or other database message authentication code) as a representation of the database. That checksum value was stored in a memory location of the electronic device containing or using the database, and the database could be accessed, used, etc., e.g., to provide access to contact information for a mobile phone, to play licensed music or movies, to display a book, to pay a toll, etc. The next time the database would be used, the same approach would be used to obtain a current checksum value, which would be compared with the previously stored checksum value. If the checksum values were the same, that would be indicative that the integrity of the database had been maintained; but if the checksum values differed, that would be indicative of an attack on the database, e.g., an unauthorized accessing of the database, a changing of a record in the database, etc. As an example, in such prior method, a hardware key or some other secret key, the secrecy of which was securely maintained, was used by a key derivation function device, e.g., an algorithm (for example, the hardware key was operated on or run through the algorithm) thereby to create a database message authentication code key. The message authentication code key was applied to the database in a message authentication code device, e.g., using a hash function or some other function, to create the mentioned checksum or other representation of the database. The checksum or other representation could be stored for subsequent comparison, as was mentioned above. If the integrity of the database was not confirmed, then various approaches could be taken to prevent access or use of the database so that unauthorized use is blocked (prevented), so that corrupted database records are not retrieved, etc. The blocked database may be replaced by a known copy of the prior database, the integrity of which was known so that the electronic device and the database could be used successfully again.

### SUMMARY

A problem with implementing database integrity protection and replay protection in electronic devices such as, for example, mobile phones, is that such replay protection can significantly impact performance of the electronic device. This performance impact can be due to an increased load placed on a processor of the electronic device in implementing the protection scheme, which in turn can result in reduced battery life and/or sluggish performance of the electronic device.

A device and method in accordance with the present invention provides a security solution that provides database integrity protection for a database by checking only one or more parts of the database, but not necessarily the entire database, for integrity.

According to one aspect of the invention, a method of protecting the integrity of a database includes: randomly selecting part of a database that is to be authenticated, said part of the database being less than the entire database to be authenticated; and processing only the selected part of the database through a security function to generate a representation of authentication of the database for comparison with another representation of authentication of the database to determine integrity.

According to one aspect of the invention, the method further includes storing the representation of authentication for comparison subsequently with such another representation of authentication.

According to one aspect of the invention, the method further includes subsequent to said randomly selecting and generating a representation of authentication, generating such another representation authentication by selecting the same part of the database, using the same function generating such another representation of authentication from the selected part of the database.

According to one aspect of the invention, the method further includes comparing the representation of authentication and the another representation of authentication, whereby matching of the representation of authentication and the another representation of authentication is indicative that the integrity of the database has not been compromised.

According to one aspect of the invention, wherein randomly selecting a part comprises selecting more than one part of the database.

According to one aspect of the invention, wherein randomly selecting comprises selecting a number of parts of the database in a series.

According to one aspect of the invention, wherein randomly selecting a number of parts of the database in a series comprises selecting such parts in a non-immediately-sequential manner.

According to one aspect of the invention, wherein randomly selecting comprises using a combination of a secret key, and an algorithm to randomly make the selection.

According to one aspect of the invention, using a secret key includes using a device-unique hardware key.

According to one aspect of the invention, wherein randomly selecting comprises using a random number generator to generate random numbers used to randomly make the selection.

According to one aspect of the invention, wherein randomly selecting comprises using a keyed random filter.

According to one aspect of the invention, wherein using a keyed random filter comprises combining a hardware key and a key derivation function algorithm to generate a database filter key to determine information representing undefined portions of a database that may be selected, and combining database filter key with the output from a random number generator to provide a keyed random filter, and using the keyed random filter, selecting part of the database from which to generate a representation of the database.

According to one aspect of the invention, wherein using a function comprises using a message authentication code.

According to one aspect of the invention, the method further includes generating the message authentication code using a database method authentication code key derived from a hardware key and an algorithmic key derivation function.

According to one aspect of the invention, the method further includes preventing use of the database or erasing the database if integrity has not been determined.

According to one aspect of the invention, an electronic apparatus includes a database integrity protection that comprises: a keyed random filter adapted to select randomly part of a database to be authenticated, said part of the database being less than the entire database to be authenticated; and an authentication code adapted to process only the selected part of the database through a security function to generate a representation of authentication of the database for comparison with another representation of authentication of the database to determine integrity.

According to one aspect of the invention, the apparatus further includes a secret key, a key derivation function device adapted to provide a database filter key as a function of the secret key and the key derivation function, a random number generator, and the keyed random filter adapted in response to the database filter key and the random number generator to select randomly such part of the database.

According to one aspect of the invention, the secret key is a device-unique hardware key.

According to one aspect of the invention, the part of the database is several parts of the database.

According to one aspect of the invention, the authentication code comprises a message authentication code adapted to provide such representation based on a database message authentication code key.

According to one aspect of the invention, the representation is stored and further comprising a comparator adapted to compare the stored representation with another representation prepared from the same part of the database using the same authentication code, the comparator adapted to provide an indication of whether or not the stored representation and the another representation are the same to indicate the integrity or non-integrity of the database.

According to one aspect of the invention, the electronic device comprises at least one of a mobile phone, a media player, a gaming device, or a computer.

According to one aspect of the invention, the database comprises at least one of contacts, music, financial data or content license data.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic block diagram representation of a portion of a system in accordance with an embodiment of the present invention.

FIG. 2 is a schematic block diagram of an electronic device in accordance with an embodiment of the present invention.

FIG. 3 is a schematic view of a mobile telephone as an exemplary electronic device in accordance with an embodiment of the present invention.

FIG. 4 is a schematic block diagram of the relevant portions of the mobile telephone of FIG. 4 in accordance with an embodiment of the present invention.

FIG. 5 is a schematic diagram of a communications system in which the mobile telephone of FIG. 4 may operate.

FIG. 6 is a mixed block diagram/flow chart representing an exemplary system and method of implementing replay protection.

FIG. 7 is a mixed block diagram/flow chart illustrating another exemplary system method of implementing replay protection.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device and a computer.

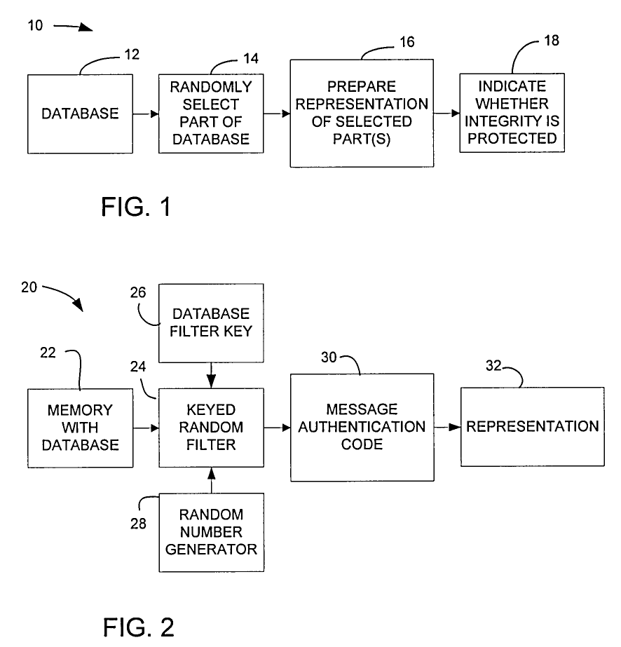

Referring initially to FIG. 1, a schematic block diagram showing a method 10 for fast database integrity protection in accordance with an embodiment of the invention is illustrated. As is illustrated in FIG. 1, a database 12 may be part of a mobile phone, e.g., stored in memory thereof, or may be part of some other electronic device, either of the portable or relatively non-portable type. At block 14 one or more parts of the database, but less than the entire database, is (are) selected randomly to be checked for integrity, e.g., to determine whether an attack had been made on such part(s), were they changed from the last time the database was accessed, used, etc. At block 16 a representation of the selected part(s) of the database is prepared. In an embodiment of the invention, the representation is a checksum value that is prepared by applying to the selected part(s) of the database a message authentication code or function. The representation may be other than a checksum value. In an embodiment the message authentication code may be a hash function or some other function. The representation, e.g., the checksum value, may be stored in the electronic device for subsequent comparison with a subsequently prepared representation, e.g., a subsequent checksum value, the next time the database is opened, accessed, used, etc. Block 18 an indication may be provided as to whether the integrity of the database had been protected. Such indication may be, for example, a blocking of further use of the database, erasing of the database, providing a visual or audible signal, etc.

By using or selecting only one or more parts of the database and preparing the representation, e.g., a checksum value, of that/those parts of the database without having to use the entire database, the time required to do the preparation and the subsequent comparison ordinarily would be less than the time required to use the entire database for such purpose. Thus, the method in accordance with the present invention are relatively more time efficient than prior methods that used the entire database.

Also, by randomly selecting different respective part or parts of the database that are used to prepare the representation, e.g., the checksum value, it is relatively unlikely that an attacker would be able to know which part(s) of the database is (are) protected and used to prepare the representation. Since the part(s) of the database used to prepare the representation is (are) randomly selected, as is described further below, such part may be different, an attacker who knows that a particular part of the database is unprotected will not necessarily know which part is protected a different time.

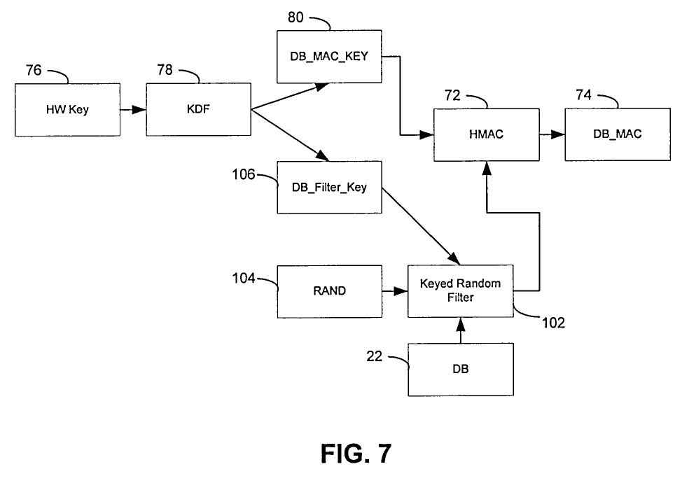

In FIG. 2 a block diagram of an electronic device 20 schematically illustrates several portions of the electronic device that can carry out the method steps mentioned above with respect to FIG. 1. The electronic device includes a memory 22 in which a database can be provided, stored, etc. The database may include data pertaining to contacts, e.g., names, telephone numbers, email addresses, street addresses, other comments, etc., of persons and/or companies, etc., for use in a mobile phone, PDA or some other electronic device. The database may include data pertaining to music, movies, books, tokens, or other information, data, etc. that may be stored in a memory, for example. A keyed random filter 24 that receives inputs from a database filter key 26 and from a random number generator 28, randomly selects one or more parts of the database to be operated on by a message authentication code device 30 to prepare the representation 32, e.g., a checksum, as was mentioned above. Further details of the electronic device 20 and the components and operation thereof are described in greater detail below with respect to FIGS. 6 and 7.

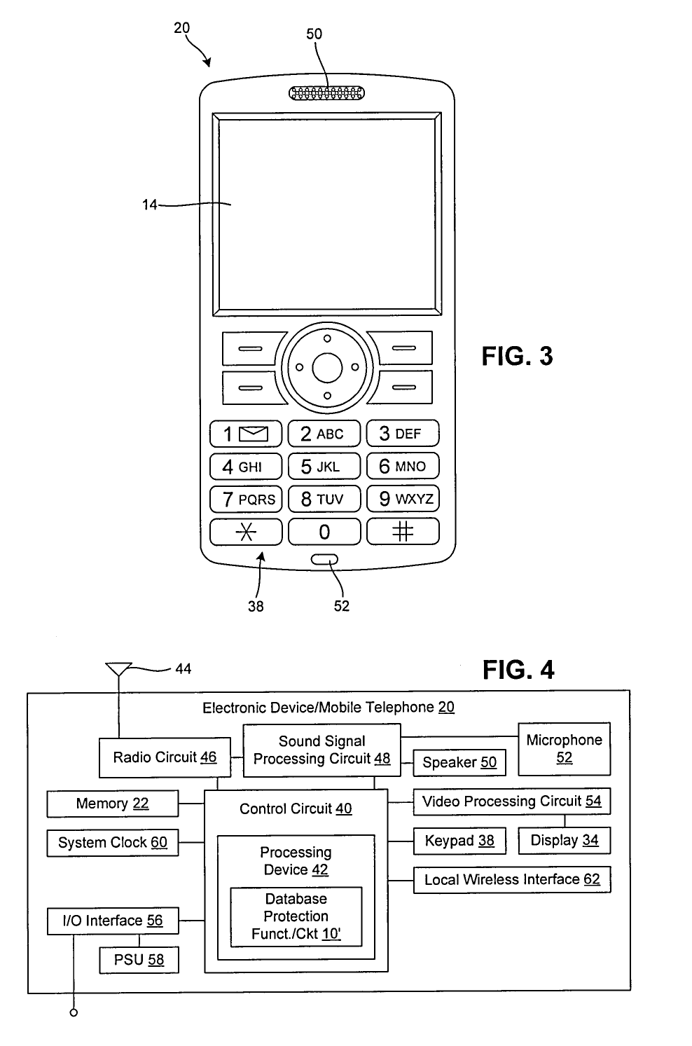

Referring to FIGS. 3 and 4, an electronic device 20 is shown. The electronic device 20 includes database integrity protection function 10′ (the reference numeral 10′ is used to designate the database integrity protection function since it is that function, possibly along with other portions of the electronic device 20, that may be used to carry out the method 10 described generally with respect to FIG. 1 and also in further detail elsewhere herein). The database integrity protection function sometimes may be referred to herein as replay protection function.

The electronic device 20 is configured to provide database integrity protection for data stored on the electronic device (e.g., a database 12 or the like). Further, the database integrity protection function 10′ does not utilize significant processing power because it can work using less than the entire database 12, thereby increasing battery life and freeing resources for other tasks. Also, since the database integrity protection function 10′ works on only a randomly selected part(s) of the database, it is relatively fast acting. Additional details and operation of the database integrity protection function 10′ will be described in greater detail below. The database integrity protection function 10′ may be embodied as executable code that is resident in and executed by the electronic device 20. In one embodiment, the database integrity protection function 10′ may be a program stored on a computer or machine readable medium. The database integrity protection function 10′ may be a stand-alone software application or form a part of a software application that carries out additional tasks related to the electronic device 20.

The electronic device of the illustrated embodiment is a mobile telephone and will be referred to as the mobile telephone 20. The mobile telephone 20 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 20 may include a display 34. The display 34 displays information to a user such as operating state, time, telephone numbers, contact information, various navigational menus, etc., which enable the user to utilize the various features of the mobile telephone 20. The display 34 also may be used to display visually content received by the mobile telephone 20 and/or retrieved from a memory 22 (FIG. 4) of the mobile telephone 20. The display 34 may be used to present images, video and other graphics to the user, such as photographs, mobile television content and video associated with games.

A keypad 38 provides for a variety of user input operations. For example, the keypad 38 typically includes alphanumeric keys for allowing entry of alphanumeric information such as telephone numbers, phone lists, contact information, notes, etc. In addition, the keypad 38 typically includes special function keys such as a “call send” key for initiating or answering a call, and a “call end” key for ending or “hanging up” a call. Special function keys also may include menu navigation and select keys to facilitate navigating through a menu displayed on the display 34. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 34. Also, the display 34 and keypad 38 may be used in conjunction with one another to implement soft key functionality.

The mobile telephone 20 includes call circuitry that enables the mobile telephone 20 to establish a call and/or exchange signals with a called/calling device, typically another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 20 may be configured to transmit, receive and/or process data, such as text messages (e.g., a text message is commonly referred to by some as “an SMS,” which stands for short message service), instant messages, electronic mail messages, multimedia messages (e.g., a multimedia message is commonly referred to by some as “an MMS,” which stands for multimedia message service), image files, video files, audio files, ring tones, streaming audio, streaming video, data feeds (including podcasts) and so forth. Processing such data may include storing the data in the memory 16, executing applications to allow user interaction with data, displaying video and/or image content associated with the data, outputting audio sounds associated with the data and so forth.

FIG. 4 represents a functional block diagram of the mobile telephone 20. For the sake of brevity, generally conventional features of the mobile telephone 20 will not be described in great detail herein. The mobile telephone 20 includes a primary control circuit 40 that is configured to carry out overall control of the functions and operations of the mobile telephone 20. The control circuit 40 may include a processing device 42, such as a CPU, microcontroller or microprocessor. The processing device 42 executes code stored in a memory (not shown) within the control circuit 40 and/or in a separate memory, such as the memory 22, in order to carry out operation of the mobile telephone 20. The memory 22 may be, for example, one or more of a buffer, a flash memory, a hard drive, a removable media, a volatile memory, a non-volatile memory, a random access memory (RAM), or other suitable device.

In addition, the processing device 32 may execute code that implements the database integrity protection function 10′. It will be apparent to a person having ordinary skill in the art of computer programming, and specifically in application programming for mobile telephones or other electronic devices, how to program a mobile telephone 20 to operate and carry out logical functions associated with the database integrity protection function 10′ as described herein. Accordingly, details as to specific programming code have been left out for the sake of brevity. Also, while the database integrity protection function 10′ is executed by the processing device 42 in accordance with a preferred embodiment of the invention, such functionality could also be carried out via dedicated hardware, firmware, software, or combinations thereof, without departing from the scope of the invention. Any of these implementations may be referred to as a database integrity protection circuit also referred to by reference numeral 10′.

Continuing to refer to FIGS. 3 and 4, the mobile telephone 20 includes an antenna 44 coupled to a radio circuit 46. The radio circuit 46 includes a radio frequency transmitter and receiver for transmitting and receiving signals via the antenna 44 as is conventional. The radio circuit 46 may be configured to operate in a mobile communications system and may be used to send and receive data and/or audiovisual content. Receiver types for interaction with a mobile radio network and/or broadcasting network include, but are not limited to, GSM, CDMA, WCDMA, GPRS, WiFi, WiMax, DVB-H, ISDB-T, etc., as well as advanced versions of these standards.

The mobile telephone 20 further includes a sound signal processing circuit 48 for processing audio signals transmitted by and received from the radio circuit 46. Coupled to the sound processing circuit 48 are a speaker 50 and a microphone 52 that enable a user to listen and speak via the mobile telephone 20 as is conventional. The radio circuit 46 and sound processing circuit 48 are each coupled to the control circuit 40 so as to carry out overall operation. Audio data may be passed from the control circuit 40 to the sound signal processing circuit 48 for playback to the user. The audio data may include, for example, audio data from an audio file stored by the memory 22 and retrieved by the control circuit 40, or received audio data such as in the form of streaming audio data from a mobile radio service. The sound processing circuit 48 may include any appropriate buffers, decoders, amplifiers and so forth.

The display 34 may be coupled to the control circuit 40 by a video processing circuit 54 that converts video data to a video signal used to drive the display 34. The video processing circuit 54 may include any appropriate buffers, decoders, video data processors and so forth. The video data may be generated by the control circuit 40, retrieved from a video file that is stored in the memory 22, derived from an incoming video data stream that is received by the radio circuit 48 or obtained by any other suitable method.

The mobile telephone 20 may further include one or more I/O interface(s) 56. The I/O interface(s) 56 may be in the form of typical mobile telephone I/O interfaces and may include one or more electrical connectors. As is typical, the I/O interface(s) 56 may be used to couple the mobile telephone 20 to a battery charger to charge a battery of a power supply unit (PSU) 538 within the mobile telephone 20. In addition, or in the alternative, the I/O interface(s) 56 may serve to connect the mobile telephone 20 to a headset assembly (e.g., a personal handsfree (PHF) device) that has a wired interface with the mobile telephone 20. Further, the I/O interface(s) 56 may serve to connect the mobile telephone 20 to a personal computer or other device via a data cable for the exchange of data. The mobile telephone 10 may receive operating power via the I/O interface(s) 56 when connected to a vehicle power adapter or an electricity outlet power adapter.

The mobile telephone 20 also may include a system clock 60 for clocking the various components of the mobile telephone 20, such as the control circuit 40. The control circuit 40 may, in turn, carry out timing functions, such as timing the durations of calls, generating the content of time and date stamps, and so forth.

The mobile telephone 20 also may include a local wireless interface 62, such as an infrared transceiver and/or an RF interface (e.g., a Bluetooth interface), for establishing communication with an accessory, another mobile radio terminal, a computer or another device. For example, the local wireless interface 62 may operatively couple the mobile telephone 20 to a headset assembly (e.g., a PHF device) in an embodiment where the headset assembly has a corresponding wireless interface.

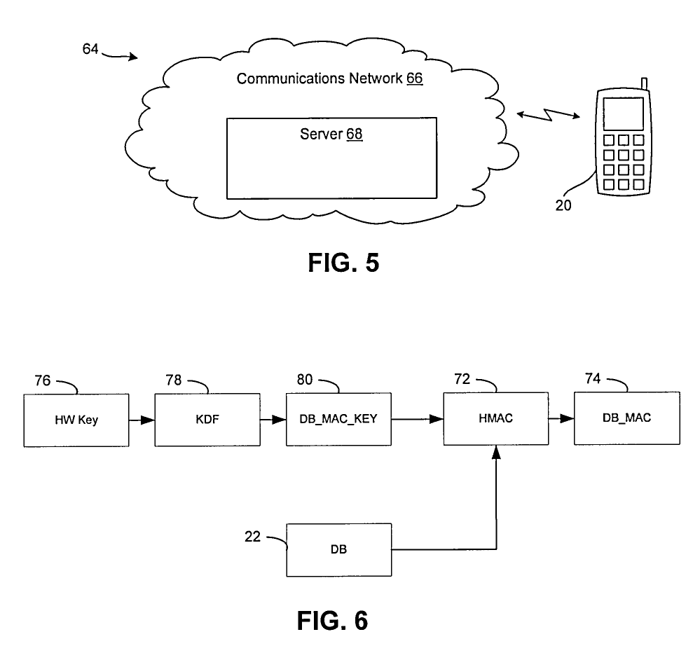

With additional reference to FIG. 5, the mobile telephone 20 may be configured to operate as part of a communications system 64. The system 64 may include a communications network 66 having a server 68 (or servers) for managing calls placed by and destined to the mobile telephone 20, transmitting data to the mobile telephone 10 and carrying out any other support functions. The server 68 communicates with the mobile telephone 20 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 66 may support the communications activity of multiple mobile telephones 20 and other types of end user devices. As will be appreciated, the server 68 may be configured as a typical computer system used to carry out server functions and may include a processor configured to execute software containing logical instructions that embody the functions of the server 68 and a memory to store such software.

Briefly referring to FIG. 6, a schematic block diagram of a system/method 70 (referred to hereinafter as system 70) that can be part of the mobile phone 20 and used to protect database integrity by checking the entire database is shown. Such system 70 includes providing the entire database 12 to a message authentication code device 72 that would prepare, e.g., compute or otherwise form, a database authentication message code 74, e.g., a checksum value (or other database message authentication code) as a representation of the database. The database message authentication code 74 can be a relatively short number, data, value, etc., of, for example 20 bytes more or less; and this is relatively small compared to the database size, which may be several megabytes in length. The calculated checksum value may be stored in a location in the memory 22 of the electronic device 22 containing or using the database, and the database could be accessed, used, etc., e.g., to provide access to contact information for a mobile phone, to play licensed music or movies, to display a book, to pay a toll, etc. The next time the database would be used, the same approach would be used to obtain a current checksum value, which would be compared with the previously stored checksum value. If the checksum values were the same, that would be indicative that the integrity of the database had been maintained; but if the checksum values differed, that would be indicative of an attack on the database, e.g., an unauthorized accessing of the database, a changing of a record in the database, etc.

As an example, a hardware key 76 or some other secret key, the secrecy of which was securely maintained, is used by a key derivation function device 78, e.g., an algorithm (for example, the hardware key was operated on or run through the algorithm), thereby to create a database message authentication code key 80. The message authentication code key may be applied to the entire database in the message authentication code device 72, e.g., using a hash function or some other function, to create the mentioned checksum or other representation of the database. The checksum or other representation could be stored in the memory 22 for subsequent comparison, as was mentioned above. If the integrity of the database was not confirmed, then various approaches could be taken to prevent access or use of the database so that unauthorized use is blocked (prevented), so that corrupted database records are not retrieved, etc., and/or the database or parts thereof even may be erased. The erased database or blocked database may be replaced by a known copy of the prior database, the integrity of which was known so that the electronic device and the database could be used successfully again.

The system 70 may be used provide a security solution that gives database integrity protection and/or replay protection on a mobile phone. All security measures can be handled external to the database and, thus, an inner structure of the database need not be modified. The system 70 and the described method of using it, however, are somewhat slow in that the database message authentication code key is applied to the entire database 12 at the message authentication code device 72, which can take a relatively large amount of time, especially if the database is a large one. In this system 70 the database message authentication code is recalculated whenever the database, e.g., in the memory 22, is updated, e.g., whenever a new record is added or whenever a record is updated. The database message authentication code is verified each time the database is opened for reading, and this may take too much time for efficient use of the database and the mobile phone in which it is used.

In using the system 70, when a new record is added to the database, the hardware key then is put into the key derivation function to generate a specific key that is used to protect the database 12. That specific key is referred to as the database message authentication code key 80. The entire database is run through the message authentication code function 72, which calculates a checksum, for example, on the entire database using the database message authentication key 80

The database message authentication value at 74 is saved; and whenever the database is opened again, e.g., for reading or to read an item from the database, then the reverse operation is carried out to verify that the database had not been modified. To do this, the hardware key 76 is used and run through the key derivation function 78 to generate the database message acquisition code key 80. Then, using the database message acquisition code key 80, the database is run through the message authentication code function 72 and the checksum value at 74 is compared with the prior checksum value to determine whether they are the same. If the same, then there has not been an attack on the database; the database integrity had been maintained. If they do not match, then an attack or some other problem occurred to the database.

A fast database integrity protection system and method 100 (referred to hereinafter as system 100) are illustrated in FIG. 7 and described below. In FIG. 7, the method 10 (FIG. 1) and mobile phone system 20 (FIGS. 2-5) are described with regard to protecting database integrity using a relatively small portion of the database 12 in such a way that it is difficult for an attacker to determine the exact location of the protected areas, e.g., correctly configured there is a high probability that a modification to the database, e.g., an attack, would be detected.

The system 100 that is part of the mobile phone 20, which is described above, limits the amount of data from the database 12 that is protected with a database message authentication code. This is done in such a way that it is difficult for an attacker to find and to modify unprotected parts of the database. The system 100 accomplishes this method by applying a keyed random filter 102 to randomly select data from the database 12 that is protected. The keyed random filter 102 reads N blocks of X bytes from locations in the database 12 based on a random number provided by a random number generator 104 and a database filter key 106, which is derived from the hardware key 76 using the key derivation function 78.

The parameters N and X mentioned above are configurable in order to trim the solution of the invention to tend to maximize performance given the physical structure of the database and the flash file system (or other system or memory) on which it is stored. A new random number provided by the random number generator 104 may be of a desired size, e.g., a 20 byte random number or some other random number. The random number can be generated each time the database message authentication code is recalculated at 80. The random number value is stored together with the database message authentication code, as is described below.

As is seen in FIG. 7, the system 100 includes a hardware key 76. This is a secure key that usually is difficult if not impossible to change; usually it is in hardware or in a secure memory location in the control circuit 40 or memory 36 (FIG. 4) or elsewhere in the operating circuitry of the mobile phone 20. To avoid or to minimize access to the hardware key 76 so that it would not be discovered, damaged or changed, the hardware key is provided to a key derivation function 78. The key derivation function 78 may be an algorithm in a computer, software, operating circuitry of the mobile phone 20, etc., and from the hardware key the key derivation function 78 provides an input to the database message authentication code key 80 and also provides an input to a database filter key 106. Thus, the key derivation function 78 generates new keys from the hardware key 76; and the new keys are used instead of the hardware key. Note that it may be relatively easy to change the key derivation function 78, if necessary, but it is relatively difficult or impossible to change the hardware key 76.

The database filter key 106 is a secret value used to assure that the function that selects one or more parts of the database also is secret. The database filter key 106 is generated from the hardware key 76 and the key derivation function 78. It could be generated by some internal function of the circuitry of the mobile phone 20 or in some other way. The manner in which the database filter key is generated is not critical; but it is desirable that it be kept secret so that a potential attacker cannot determine what part(s) of the database is (are) protected.

The random number from the random number generator 104 and the database filter key 106 are used by the keyed random filter 102 to select one or more entries from the database 22 that are to be sent to the message authorization code device 72. The message authorization code device 72 then uses this data along with the database message authentication code key 80 to prepare or to generate a representation of the database, e.g., a checksum value.

The random number from the random number generator 104 can be stored together with the database message authentication code value from 74. Therefore, when a subsequent operation is carried out to verify that the database integrity had been protected, it is necessary to find exactly what part(s) of the database actually had been protected. The random value does not have to be stored securely; it only has to be available for use.

To verify whether database integrity had been maintained, the previously stored representation of the database, e.g., the checksum value, is compared to a newly computed, e.g., a subsequently prepared, representation of the database. This is done by using a keyed random filter 102 to generate filtered data for use by the message authentication function 72. To generate the filtered data, the keyed random filter function 102 receives as input the stored random number (as stored with the database message authentication code value 74 above) to select the same part(s) of the database as had been previously selected, along with the database filter key generated by the database filter key function 106.

The database message authentication code key 80 and the selected part(s) of the database (i.e., the filtered data), which should be the same as the previously randomly selected part(s) of the database, is applied to such part(s) of the database at the message authentication code 72 to prepare the subsequent representation of the database. If the subsequent representation and the previously stored representation are the same, then probably there has been no attack on the database; if they are different, then it is probable that there was an attack.

In the description above, the several parts of the drawing are designated by reference numerals and blocks are shown with letter abbreviations to minimize space. The abbreviations are, as follows:

HW_key is hardware key 76.

KDF is key derivation function 78.

DB_MAC_Key 80 is the database message authentication code key.

DB_Filter_Key 106 is the database filter key.

RAND 104 is the random number generator.

DB 22 is the database, for example, which may be stored in the memory 22 or elsewhere.

HMAC 72 is a message authentication code; the letter H designating an example of a specific type of such device, such as one that operates using a hash function.

DB_MAC 74 is the database machine access code that is generated using the HMAC, for example. The value in the DB_MAC 74 may be the checksum value or some other value or representation of the database; and may be stored for subsequent comparison, as was described above.

To further strengthen the ability of the method and system described above to protect integrity of the database, it is possible to update the probabilistic message authentication code when reading the data to make it more difficult for an attacker to find the unprotected areas of the database.

Performance of the keyed random filter 102 can be optimized or enhanced by first producing random addresses in a buffer, e.g., in the memory 22, and then sort them to step linearly through the file to optimize the cache hit rate as parts of the database are sent through the keyed random filter 102.

The parts of the database that are randomly selected may be serial and may or may not be sequential. For example, there may be parts that are in sequential order in the database structure, say parts 1, 2, 3, 4, 5, 6, 7, 8, 9, but only parts 1, 3 and 9 are the randomly selected parts.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of protecting the integrity of a database, comprising
randomly selecting part of a database that is to be authenticated, said part of the database being less than the entire database to be authenticated; and
processing only the selected part of the database through a security function to generate a representation of authentication of the database for comparison with another representation of authentication of the database to determine integrity.

2. The method of claim 1, further comprising storing the representation of authentication for comparison subsequently with such another representation of authentication.

3. The method of claim 2, further comprising subsequent to said randomly selecting and generating a representation of authentication, generating such another representation authentication by selecting the same part of the database, using the same function generating such another representation of authentication from the selected part of the database.

4. The method of claim 3, further comprising comparing the representation of authentication and the another representation of authentication, whereby matching of the representation of authentication and the another representation of authentication is indicative that the integrity of the database has not been compromised.

5. The method of claim 1, said randomly selecting a part comprises selecting more than one part of the database.

6. The method of claim 5, said randomly selecting comprises selecting a number of parts of the database in a series.

7. The method of claim 6, said randomly selecting a number of parts of the database in a series comprises selecting such parts in a non-immediately-sequential manner.

8. The method of claim 1, said randomly selecting comprising using a combination of a secret key, and an algorithm to randomly make the selection.

9. The method of claim 8, wherein using a secret key includes using a device-unique hardware key.

10. The method of claim 1, said randomly selecting comprising using a random number generator to generate random numbers used to randomly make the selection.

11. The method of claim 1, said randomly selecting comprising using a keyed random filter.

12. The method of claim 11, said method of using a keyed random filter comprises combining a hardware key and a key derivation function algorithm to generate a database filter key to determine information representing undefined portions of a database that may be selected, and combining database filter key with the output from a random number generator to provide a keyed random filter, and using the keyed random filter, selecting part of the database from which to generate a representation of the database.

13. The method of claim 1, said using a function comprises using a message authentication code.

14. The method of claim 13, further comprising generating the message authentication code using a database method authentication code key derived from a hardware key and an algorithmic key derivation function.

15. The method of claim 1, further comprising preventing use of the database or erasing the database if integrity has not been determined.

16. Electronic apparatus including a database integrity protection, comprising,
a keyed random filter adapted to select randomly part of a database to be authenticated, said part of the database being less than the entire database to be authenticated; and
an authentication code adapted to process only the selected part of the database through a security function to generate a representation of authentication of the database for comparison with another representation of authentication of the database to determine integrity.

17. The electronic apparatus of claim 16, further comprising a secret key, a key derivation function device adapted to provide a database filter key as a function of the secret key and the key derivation function, a random number generator, and the keyed random filter adapted in response to the database filter key and the random number generator to select randomly such part of the database.

18. The electronic apparatus of claim 17, wherein said secret key is a device-unique hardware key.

19. The electronic apparatus of claim 16, wherein the part of the database is several parts of the database.

20. The electronic apparatus of claim 16, wherein said authentication code comprises a message authentication code adapted to provide such representation based on a database message authentication code key.

21. The electronic device of claim 16, wherein the representation is stored and further comprising a comparator adapted to compare the stored representation with another representation prepared from the same part of the database using the same authentication code, the comparator adapted to provide an indication of whether or not the stored representation and the another representation are the same to indicate the integrity or non-integrity of the database.

22. The electronic device of claim 16, comprising at least one of a mobile phone, a media player, a gaming device, or a computer.

23. The electronic device of claim 16, wherein said database comprises at least one of contacts, music, financial data or content license data.
